(19) United States
(12) Patent Application Publication
(10) Pub. No.: US 2008/0304105 A1
(43) Pub. Date: Dec. 11, 2008

(54) Data management for media production

(76) Inventors: Michael R. Moore, Folsom, CA (US); Daniel A. Kave, Folsom, CA (US); Kenneth A. Turcotte, Folsom, CA (US); Randy J. Jongens, Folsom, CA (US); Michael D. Wang-Helmke, Carmichael, CA (US); Peter A. Tjeerdsma, Fair Oaks, CA (US); Christopher H. Davey, Sacramento, CA (US); Daniel N. Sashko, Roseville, CA (US)

Correspondence Address: CARR & FERRELL LLP, 2200 GENG ROAD, PALO ALTO, CA, 94303, US

(21) Appl. No.: 12/156,345

(22) Filed: May 30, 2008

Related U.S. Application Data
(60) Provisional application No. 60/932,697, filed on May 31, 2007.
(60) Provisional application No. 60/932,711, filed on May 31, 2007.
(60) Provisional application No. 60/932,853, filed on May 31, 2007.

(51) Int. Cl. G06F 3/12

(52) U.S. Cl. 358/1.15

(57) ABSTRACT

Systems and methods for authoring, ordering and producing various products are described. A method of ordering a product comprises: receiving a request for a product type, identifying product specification data associated with the product type, presenting one or more options for products characterized by the product specification data, receiving a request for one or more of the presented options, and transmitting product order data associated with the request to a server. A method of producing an ordered product comprises: receiving product order data associated with the authored product, identifying print output data associated with the authored product, generating one or more tables of contents, each table of contents defining one or more components of the authored product, and printing the product components defined by the tables of contents.

### CROSS REFERENCE TO RELATED APPLICATIONS

This application claims the benefit of U.S. provisional patent application No. 60/932,697, filed May 31, 2007, entitled “Systems and Methods for Electronic Data Management for Media Production;” U.S. provisional patent application No. 60/932,711, filed May 31, 2007, entitled “Systems and Methods for Clustering Media According to Themes;” and U.S. provisional patent application No. 60/932,853, filed May 31, 2007, entitled “Systems and Methods for Rendering Media;” each of which is incorporated herein by reference. This application is related to U.S. patent application Ser. No. ______, filed May 30, 2008, entitled “Systems and Methods for Rendering Media,” attorney docket number PA4266US, which is incorporated herein by reference. This application incorporates by reference U.S. patent application Ser. No. 11/437,207 filed May 19, 2006 entitled “Systems and Methods for Web Server Based Media Production,” and U.S. patent application Ser. No. 11/711,550, filed Feb. 26, 2007 entitled “Systems and Methods for Dynamically Designing a Product with Digital Content.”

### BACKGROUND OF THE INVENTION

1. Field of the Invention

The present invention relates generally to media production, and more particularly to systems and methods for electronic data management for media production.

2. Description of Related Art

Conventionally, computer applications may be used to arrange and view items of digital content on a virtual page that may later be printed as hard copy. Often, each virtual page (or book block) corresponds to a physical page in the hard copy, and a group or album of virtual pages corresponds to an album or group of hard copy pages (e.g., a photo album or calendar). The computer application may be used to

The computer application may be used to order printed copies of the finished photo album in a variety of formats. Sometimes, different copies of an album may have different sizes and/or cover styles.

The photos and associated selections made via the computer application may be saved as multiple electronic files, or print-ready artwork may be produced and saved in a single multi-page file such as a PDF, or as multiple image files such as JPG. The electronic files may be electronically transmitted to a server associated with a production facility for generating the one or more ordered hardcopy photo albums or photo books.

In some cases, a particular user may wish to create multiple photo albums, with each album having substantially the same page content, but with some variations of certain content for each album depending on the styles and/or sizes ordered, (e.g. a printed cover on a hard or soft cover book, an internal title page for a hardcover book, a through-hole die-cut in a hardcover, or multiple sizes of the same book such as 11″ by 8.5″ or 8″ by 6″).

Such changes in format, page ordering or physical dimension typically require the creation of separate electronic files for each photo album configuration. These separate electronic files are often comprised of high-resolution photos and the associated layout settings describing layout information such as photo size and placement on each page. In other instances, these electronic files include print-ready final page artwork unique to each finished book that has been ordered. Each of these approaches requires a large amount of computer memory storage space, processing power, and/or network transmission bandwidth, especially when transmitting an order from an internet user to a production facility that produces photo albums on a mass production basis. There is therefore a need for systems and methods for more efficient electronic data management for media production.

### SUMMARY OF THE INVENTION

Various exemplary embodiments include a method for authoring a product. Methods may include receiving a choice of product type, determining product specification data associated with the chosen product type, populating one or more components of a product with content, generating print output data associated with the populated components, and storing the print output data.

In some embodiments, populating includes prompting a user to input content and/or receiving content from a user. In some aspects, content may be arranged or laid out automatically. In various aspects, content may be photographs, text, background information, theme information, graphical information or other information.

In some aspects, storing print output data includes storing the print output data on a production server. In some cases, the production server is associated with a printer.

Various exemplary methods of ordering an authored product include receiving a request for an authored product type, identifying product specification data associated with the authored product type, presenting one or more options for authored products characterized by the product specification data, receiving a request for one or more of the presented options, and transmitting product order data associated with the request to a server.

Certain exemplary methods of producing an ordered product include receiving product order data associated with the authored product, identifying print output data associated with the authored product, generating one or more tables of contents, and printing the product components defined by the tables of contents.

In select embodiments, print output data include a PDF file, a JPG file, Extensible Markup Language (XML) information, or a TIFF file. Print output data may correspond to various product components, including book blocks, pages, cover sheets, dust jackets, hard covers, soft covers, or other components.

Certain other embodiments include a computer readable storage medium having embodied thereon a program, the program executable by a processor and operable to perform one or more methods described herein.

### BRIEF DESCRIPTION OF THE DRAWINGS

FIG. 1 is a schematic showing several features of an exemplary product component, according to various embodiments.

FIG. 2 is a schematic showing several features associated with an exemplary authored product, according to various embodiments.

FIG. 3A is a schematic showing various electronic, computing, input/output, printing and/or storage apparatus that may be used in various exemplary implementations, according to various embodiments.

FIG. 3B is a schematic showing several exemplary apparatus associated with a server, according to various embodiments.

FIG. 4 is a flow diagram of an exemplary process for creating a product, according to various embodiments.

FIG. 5 is a schematic describing several exemplary data blocks, according to various embodiments.

FIG. 6 is a flow diagram of an exemplary method for authoring a product, according to select embodiments.

FIG. 7 is a flow diagram of an exemplary method of ordering an authored product, according to certain embodiments.

FIG. 8 is a flow diagram of an exemplary method of producing one or more authored products, according to select embodiments.

### DETAILED DESCRIPTION

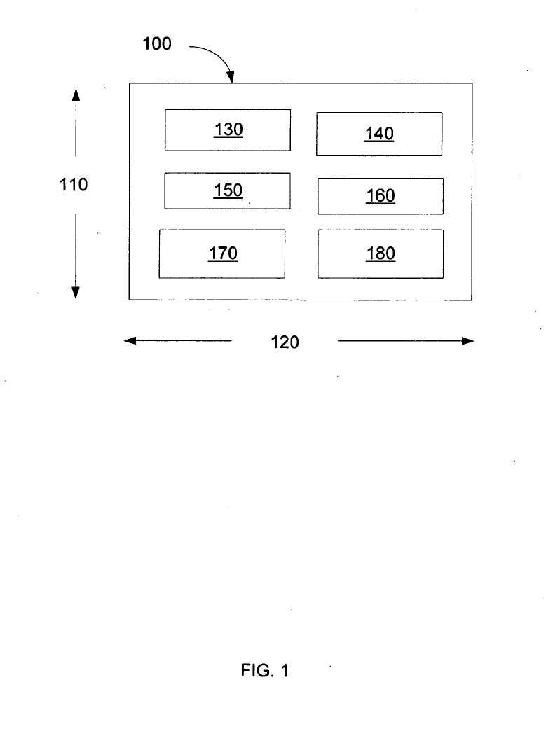

FIG. 1 is a schematic showing several features of an exemplary product component. Product component 100 may include one or more photographs 130, graphical information 140, layout information 150, effects information 160 (such as shading, lighting, blurring and other effects), text 170, and/or theme information 180 (such as “wedding” or “birthday” characteristics). These various features of product component 100 generally describe the layout of product component 100.

Product component 100 may be a page, a book block, a cover sheet, a hard cover, a dust jacket, a soft cover, or any other component of a product. A product component may be a product. A product (e.g., a poster) may be a product component.

Product component 100 is generally characterized by height 110 and length 120, whose ratio is commonly described as an aspect ratio of the product component 100. Different products may have the same aspect ratio. Different products may have slightly different aspect ratios, such as aspect ratios within 20%, 10%, 5%, or 1% of each other. Depending upon user preferences, product components with slightly different aspect ratios may be grouped together and characterized by a common product type, such that members sharing a product type are characterized by sufficiently similar aspect ratios that products or product components of the same product type may be substantially interchanged without affecting a user's perception of the product.

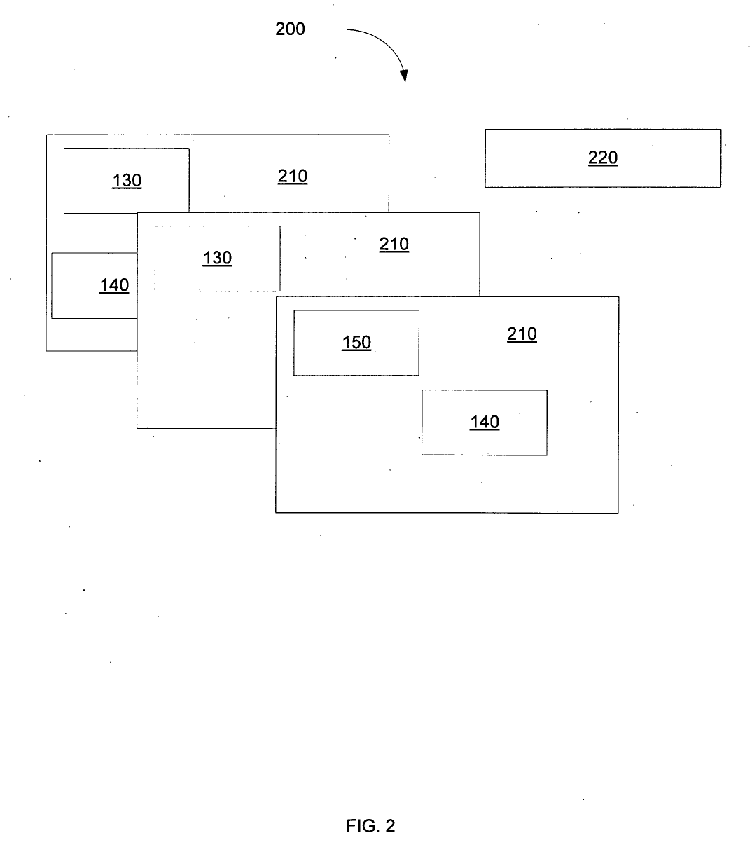

FIG. 2 is a schematic showing several features associated with an exemplary authored product, according to various embodiments. The authored product 200 includes several product components, including a plurality of pages 210. Several product components are specific to a particular type of product, and are thus defined as product specific features 220. Exemplary product specific features 220 may include a dust jacket, a hardcover, through-holes, a spiral binding, a glossy front page, or a liner page.

A given product may require several product components. A given product may be characterized by various physical dimensions such as length, height, page weight, medium, print quality, water resistance or other characteristics. For the purposes of this specification, these various characteristics are described using product specification data associated with a given product. The product specification data may also define which product components are associated with the product. The product specification data may also include a product type that is associated with the product.

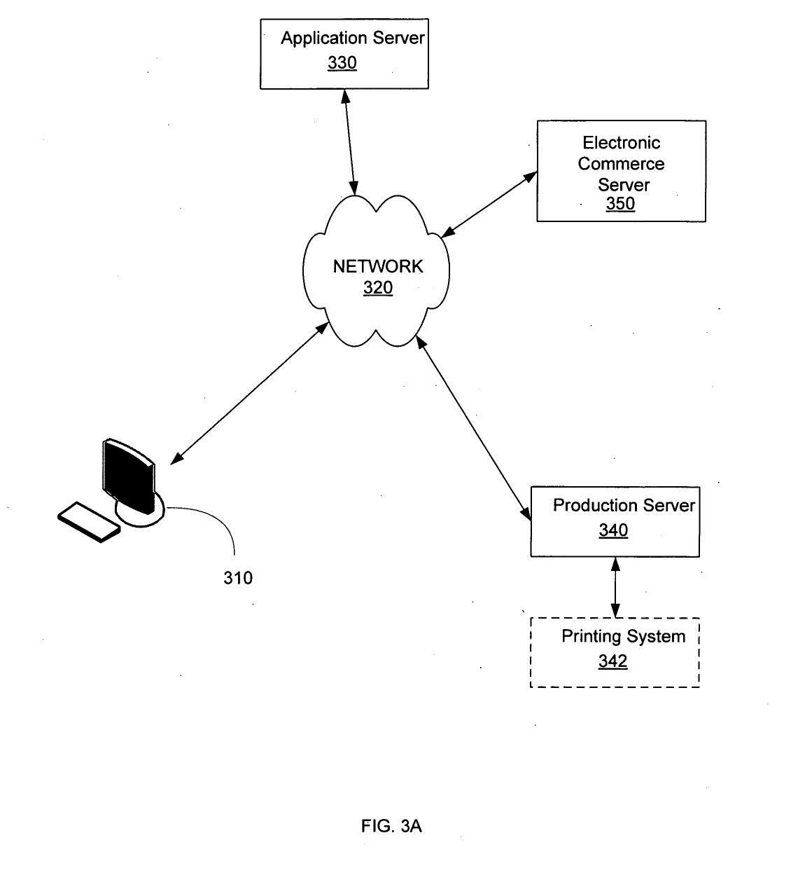

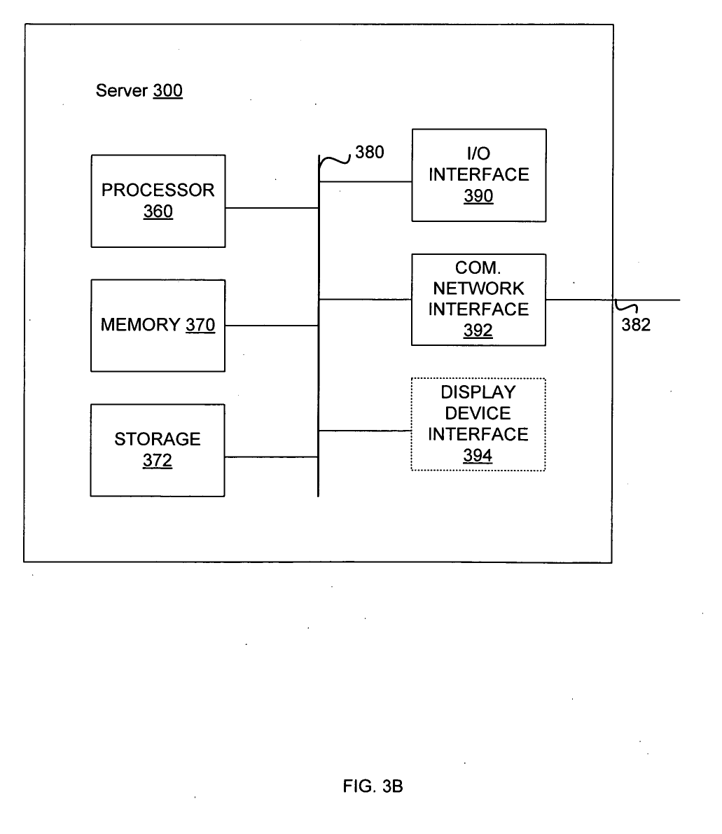

FIG. 3A is a schematic showing various electronic, computing, input/output, printing and/or storage apparatus that may be used in some exemplary implementations. FIG. 3A includes input device 310, network 320, application server 330, production server 340 (which may be connected to printing system 342), and electronic commerce server 350.

Generally, a user may provide input at input device 310, which may also provide output (e.g., display) to the user. Input device 310 may be a computer, a telephone, a cell phone, a PDA, a tablet PC, a digital camera, or any other input device. In certain aspects, input device 310 is connected via network 320 to various other apparatus, such as application server 330, production server 340 (which may interface to printing system 342), and/or electronic commerce server 350; any of these devices may include a display. These various apparatus are shown as discrete entities for illustrative purposes only; they do not necessarily reside on different machines or in different locations. Additionally, various aspects may include one or many users. Various aspects may be implemented over a network such as the internet.

Generally, printing system 342 may print using high quality digital data. For the purposes of this specification, these data are described as print output data. These data may include PDF files, JPG files, XML files, photographs, and other aspects. High quality printing may require large amounts of print output data, which may require substantial storage requirements to store the data or bandwidth requirements to transmit the data. In some aspects, it may be advantageous to site the print output data at production server 340.

FIG. 3B is a schematic showing several exemplary apparatus associated with a server. These components include server 300, which may have a processor 360, memory 370, storage 372, I/O (input/output) interface 390, communications network interface 392, and display device interface 394 (which may be optional). These aspects are generally connected via bus 380, and connect to network 320 (FIG. 3A) via connection 382. Processor 360 is generally configured to execute instructions, and storage 372 is generally configured to store information, and typically includes a computer-readable storage medium such as a hard disc drive, a flash drive, a DVD, a Compact Disc, an optical drive, or magnetic tape. I/O interface 390 may couple to any of the devices associated with an input device, including a keyboard, mouse, joystick or thumb wheel.

Connection 382 may include an Ethernet connection, a wireless connection, a USB connection, a firewire connection, a serial connection, a parallel connection, or a cellular connection.

Display device interface 394 may connect to a display such as a monitor or flat panel display. In some aspects, a display is associated with a user interface and/or input device 310 (FIG. 3A).

Server 300 may generally include appropriate software such that it can operate as a server. Typically, this software will include instructions, stored on storage 372, executable by processor 360.

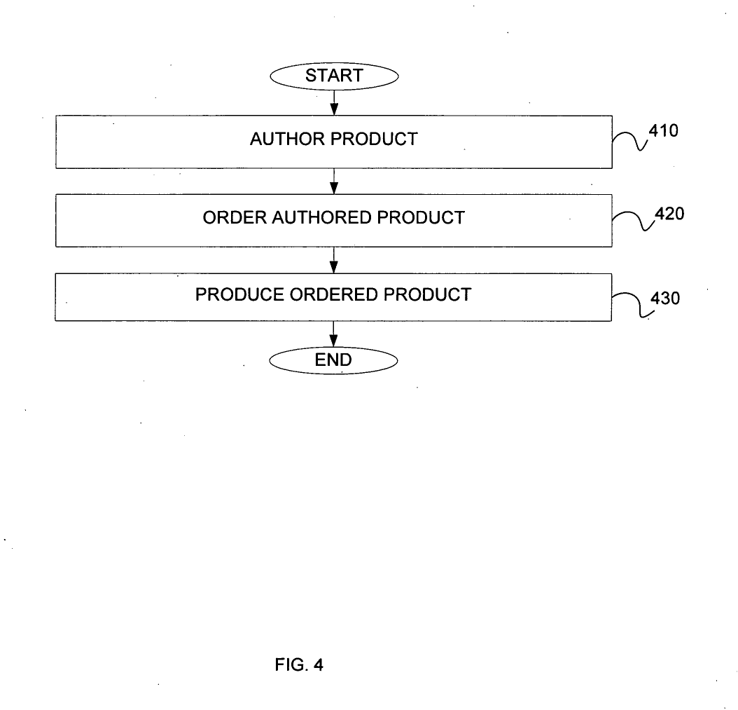

FIG. 4 is a flow diagram of an exemplary process for creating a product, according to various embodiments

In step 410, a product is authored. This generally refers to the creation of one or more product components, many of which may include customized content. Authoring may be performed by a user, although in some aspects, authoring may be automatically performed according to a computer-implemented method.

Generally, authoring includes defining a product type associated with the product to be authored and populating the required components (i.e., the product components associated with the type of product) with appropriate content. It may be advantageous to populate all of the product components associated with a product type, such that any product according to the product type can be constructed by selecting an appropriate subset of product components.

In step 420, an authored product may be ordered. In some aspects, an authored product is ordered by a user, although an authored product may also be ordered by a computer-implemented method. Generally, ordering may refer to the process of choosing a particular authored product, which may include choosing a category of product (e.g., a hardcover book, a coffee mug, or a calendar) as well as choosing various characteristics of the product (such as size). Ordering generally includes the process of notifying a production facility (e.g., a facility that makes the desired product) that the product is desired. In some aspects, ordering may include a financial transaction, and in some cases, this financial transaction may include an entity that performs electronic commerce, such as electronic commerce server 350 (FIG. 3A).

In step 430, an ordered product (e.g., an authored product that has been ordered) is produced. Typically, production refers to the creation of hard copy or another physical manifestation of the product. In some embodiments, production includes the use of product order data and product specification data.

In various aspects, an ordered product is produced at a facility including a production server such as production server 340.

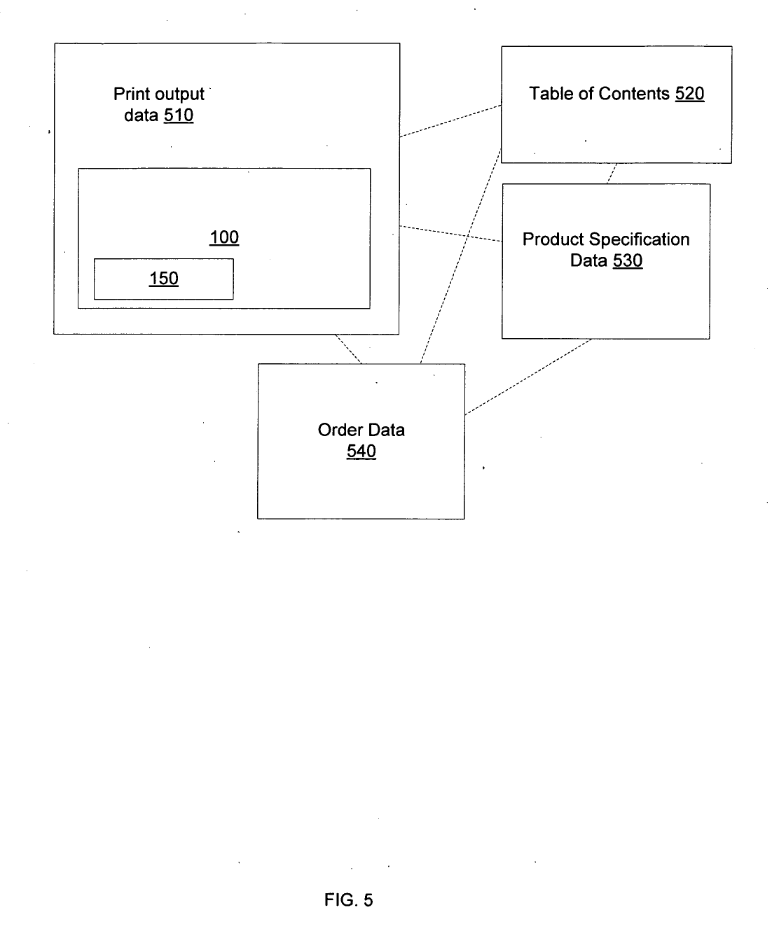

FIG. 5 is a schematic describing several exemplary data blocks, according to various embodiments. FIG. 5 includes print output data 510, table of contents 520, product specification data 530, and order data 540. These blocks may be separate from each other in some embodiments. In other embodiments, various data blocks may be integrated or combined with each other.

Print output data 510 may generally include layout information associated with each product component and typically comprises high quality data that may take substantial storage space and require significant bandwith for transmission. Print output data 510 may also include data associated with one or more photographs, text, graphics, themes, or other aspects associated with a product component 100 (FIG. 1). Print output data 510 may include a single, print-ready image associated with each product component 100. Print output data 510 may also include discrete content data (e.g., photographs) along with corresponding layout information (e.g., as an XML file). Print output data 510 may include a PDF or JPEG file. Some product components may include data input by a user (e.g., photographs provided by the user). Other product components may be generated automatically.

Table of Contents 520 is associated with, and in some aspects is an index to, print output data 510. In some aspects, Table of Contents 520 “chooses” which items of print output data 510 are produced or printed.

Table of Contents 520 may be a separate data block. Table of Contents 520 may also be integrated into print output data 510. In some aspects, print output data 510 includes a PDF file, and Table of Contents 520 is literally the table of contents associated with the PDF file. In such aspects, editing or amending Table of Contents 520 can be used to select pages from the PDF file for printing. Table of Contents 520 may be of small enough size that it may be stored, transmitted, and/or generated as needed.

Product specification data 530 typically includes data that describe the characteristics of a product, a product type, and/or an authored product. In one sense, product specification data 530 may describe the “real world constraints” on the product or product type. In some aspects, product specification data 530 is maintained as a discrete data block, and in some embodiments, product specification data 530 may be associated with electronic commerce server 350. In some aspects, electronic commerce server 350 uses product specification data 530 in order to determine product options that may be offered to a user investigating a given product or product type.

Product specification data 530 may also be used to define certain features or product components associated with a given product or product type. For example, product specification data 530 may enumerate that a hard cover book includes a product component corresponding to a dust jacket, a product component corresponding to a printed hard cover, and several product components corresponding to pages.

Product specification data 530 may include information describing the media from which a final product is made (e.g., a book, a calendar, or a coffee mug). Product specification data 530 may include a product type, such as a landscape product, a portrait product, or a square product, and may include dimensions and/or aspect ratio information. Product specification data 530 may also include constraints on the variation in various dimensions (e.g. aspect ratio) among different products within the product type. Product specification data 530 may also include a stock-keeping unit (SKU) or other standardized tracking and/or inventory information. Product specification data 530 may be small enough in size that it may be conveniently stored or generated as needed.

In certain aspects, Table of Contents 520 selects a subset of all the available product components 100. In some aspects, this selection includes the use of product-specification data 530 to define a “menu” of required product components associated with a given (i.e. specified) product. This “menu” may be incorporated into Table of Contents 520 such that Table of Contents 520 operates to select only the product components 100 corresponding to selected “menu items” from print output data 510, such that only the selected subset is printed.

Order data 540 generally describe a request or order for an authored product. A request or order may be placed by a user or via an automated entity or a combination thereof. Typically, order data 540 may include information associated with the entity (e.g., a user) ordering the product, such as contact information, shipping information, and/or billing information. Order data 540 may also include a reference to the relevant production data, such as print output data 510, table of contents 520, and production specification data 530. Order data 540 often includes one or more user choices (in a request from a user) defining a particular product to be produced, such as a choice of medium (photo album, coffee mug, etc.), size of product, shipping information, and various transaction data or financial data or data associated with electronic commerce server 350. Order data 540 may also include a stock-keeping unit (SKU) or other standardized tracking and/or inventory information. In some aspects order data 540 and product specification 530 are “connected” by incorporating a common SKU into each of them.

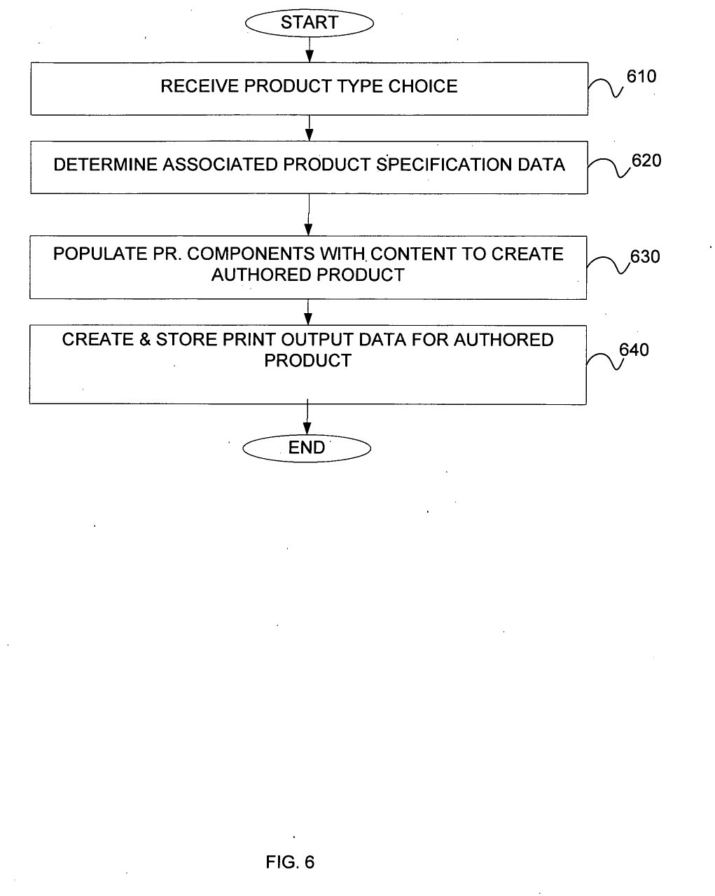

FIG. 6 is a flow diagram of an exemplary method for authoring a product, according to select embodiments. These steps may be performed with a user input device, an application server, a print server, or other computing device.

In step 610, a choice of a desired product type is received. This choice may be received from a user, or may be received from an automated entity. Generally, this step defines the general category of product that is desired.

In step 620, the product specification data associated with the chosen product type are determined. This step generally defines “what information is needed” to create the desired product.

In step 630, one or more product components (e.g., pages) are populated with content. Generally, content may refer to any customization data, such as text, photographs, themes, effects, and the like. Populating a product component with content generally refers to the incorporation of content into the product component. In some aspects, populating a product component may be described as “laying out” the features of the product component. In certain aspects, population includes prompting a user for input. In other aspects, population is automatic. In other aspects, this incorporation may include the automatic generation of certain product components from other product components (such as the creation of a dust jacket based on a cover page).

In step 640, print output data are created and stored. Generally, a “superset” of print output data may be created, such that any product of a given product type may be created by appropriately selecting a subset of the print output data (generated for that product type). In some embodiments, print output data are stored at a production server, and in such cases, the selection of different products within a given product type may be effected by selecting different subsets of the print output data. Thus in some aspects, different products may be produced without requiring multiple copies of various print output data.

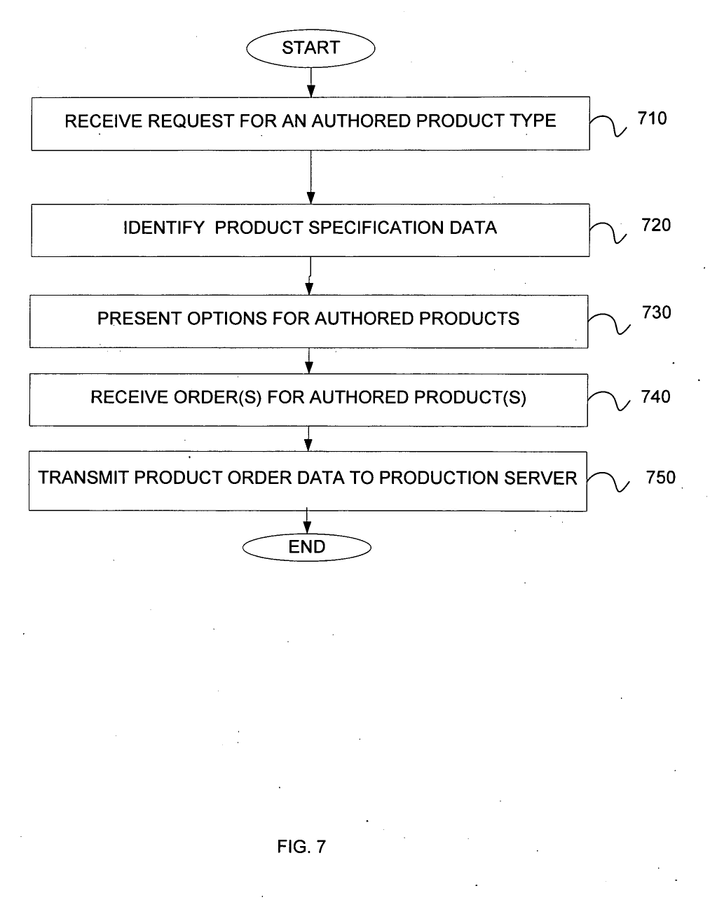

FIG. 7 is a flow diagram of an exemplary method of ordering an authored product, according to certain embodiments. In step 710, a request for an authored product type is received. The request may be received from a user. The request may also be received from an automated device. The request may include a request for a product. The request may include a request for a product associated with a theme (e.g., a product associated with a friend's wedding). The request may include sufficient information to identify a specific authored product. In some embodiments, the request requires the further specification of product details. In such cases, the need for such details may be identified using the product specification data associated with the product type.

In step 720, product specification data are identified.

In step 730, the requestor may be presented with options for different authored products (such as a desired size of a particular calendar).

In step 740, a request or an order for one or more authored products is received. Typically, this request or order may include product order information, and sufficiently defines the desired authored product that an order can be transmitted to a production facility.

In step 750, product order data may be transmitted to a production server, although in some embodiments, the production server may equivalently retrieve the product order data.

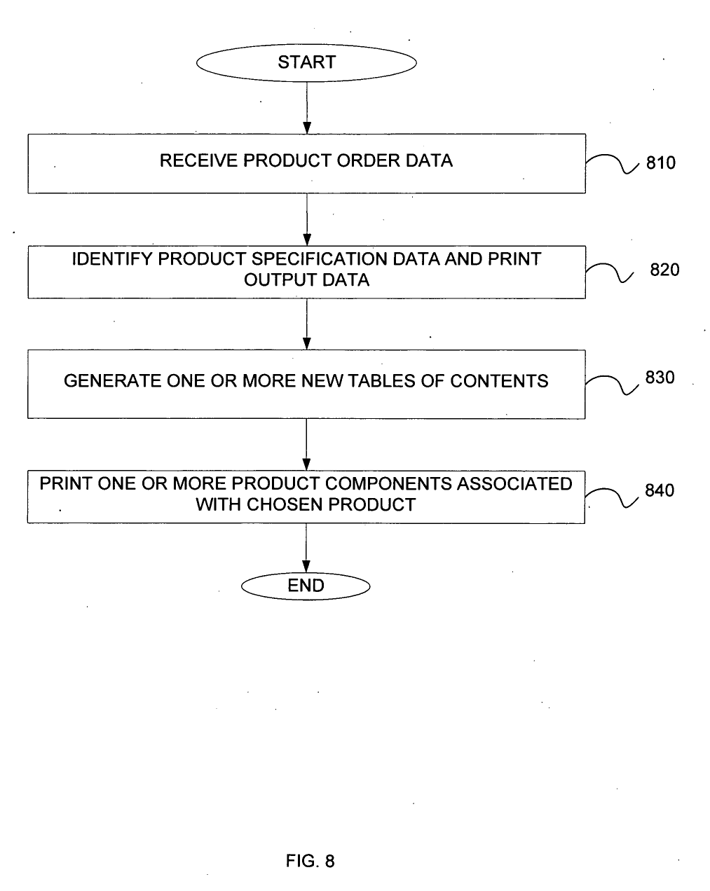

FIG. 8 is a flow diagram of an exemplary method of producing one or more authored products, according to select embodiments. It may be advantageous to perform this method at a production facility, and in some aspects, this method may be performed by a production server.

In step 810, product order data associated with an authored product are received. In certain aspects, product order data include data specifying physical characteristics of the ordered product. Product order data may also specify choices of various options associated with the authored product.

In step 820, product specification data associated with the authored product are identified. The product specification data may be included with or as part of the product order data. The product specification data may also reside locally (e.g., on a lookup table) and be identified using a key-value pair included with the product order data. The product specification data may also be retrieved from a remote site.

Step 820 also includes the identification of print output data associated with the authored product being produced. It may be advantageous to keep the print output data at a production server involved in the production of the authored product. In certain embodiments, a “superset” of the print output data necessary to produce all authored products of a given product type may be used, such that the specification or choice of a particular product simply requires the selection of a particular subset of the print output data.

In certain embodiments, two or more products may be specified for a given product type even though they have slightly different aspect ratios, provided their aspect ratios are within a range that is deemed acceptable to be produced from the same print output data. In such a case, the aspect ratio for the print output data for that product type is specified to be in the middle of the range. When printing a product that does not exactly match the aspect ratio of the print output data, the print output data is printed at a size to match or exceed the dimensions of the product as required to fill the page, and the print output data that exceeds the non-matching dimension is allowed to “bleed” past the edges or be cropped as commonly practiced in print manufacturing processes.

In step 830, one or more new Tables of Contents are created. In certain aspects, the product order data and product specification data are used to create a Table of Contents appropriate to the requested authored product. Generally, a Table of Contents may be used to select a subset of the print output data for printing, and different Tables of Contents may be used with the same print output data to select different product components.

In step 840, one or more product components associated with the requested product are printed. In some cases, different product components can be sent to different printers via their selection using specific Tables of Contents. Thus, a first Table of Contents may select a body of a book comprising many pages to be sent to a first printer, and a second Table of Contents may select a cover sheet, which (e.g. according to the product specification data) may be used to create a dust jacket, which is sent to a second printer for printing the dust jacket.

In certain aspects, the arrival of (or request for and subsequent fulfillment of) product order data at the production server triggers the creation of a new Table of Contents associated with existing print output data, often by using the product specification data to determine which product components are required for the requested product. In some cases, a new Table of Contents is appended to an existing print output data. In certain embodiments, a newer Table of Contents overrides an older Table of Contents, such that only the product components associated with the newest Table of Contents are printed.

According to various exemplary systems and methods presented herein, a single electronic file may be used to produce different products in a variety of commonly labeled sizes such as 6″×4″, 9″×6″, and 11″×8.5″. However, in this embodiment, slight dimensional changes may be made to the actual final dimensions so that they all have the same or nearly the same final aspect ratio, or relative width to height, so that they may all be produced from the same print-ready artwork.

For example, given a shared aspect ratio of 0.73, an 11″×8.5″ book could be printed at an actual size of 10.75″×7.85″ and a 9″×6″ book may be printed at 9″×6.57″, both having the same or nearly the same aspect ratio and a size similar to the commonly labeled size. Additionally, photo albums may be generated from a single electronic file with various printed covers in soft cover formats, separate dust jackets, or with a printed picture wrap on a hard cover.

In some aspects, a single rendered book block file may contain all of the information required to produce all available different sizes and cover options for a particular book. Accordingly, the size of a single electronic file for multiple photo album variations is only slightly larger than the size of the same electronic file for only one photo album variation. For a facility that mass produces photo albums for consumers, software may be installed that transforms a single book block into multiple book blocks and cover files based on order information retrieved from a central database or retrieved from the stored book block, or any other method of transmitting the customer's choices.

Based on the various exemplary systems and methods described herein, the storage and manipulation of variable print data within a single file may be achieved. A single electronic file may support production of different variations of hard copy photo albums, in contrast to the currently available systems and methods that involve multiple files. Additionally, only a single electronic file containing all page artwork need be uploaded to a production server.

For example, based on a user's size/cover selections in the original electronic file, a new electronic file may be generated on a server for each product variation by inserting variables to indicate desired size, print and binding parameters. Printing and binding instructions may be stored in both machine-readable embedded data and/or human-readable instructions visible in the gutter or crop area, extra pages, etc.

Based on other exemplary systems and methods described herein, variable user-data printing may be achieved. Pointers to postscript blocks may be stored within a single electronic file to support server-side dynamic update of digital content. Data about text-flow boundaries, vector outlines, etc. may be stored within the same electronic file, including alpha-layers for graphic elements including text with shadows, and information on how an external engine may be called to re-render selected elements.

While various embodiments have been described above, it should be understood that they have been presented by way of example only, and not limitation. Thus, the breadth and scope of a preferred embodiment should not be limited by any of the above-described exemplary embodiments.

What is claimed is:

1. A method for authoring a product comprising:
receiving a choice of product type;
determining product specification data associated with the chosen product type;
populating one or more components of a product with content, the product associated with the product specification data;
generating print output data associated with the populated components; and
storing the print output data.

2. The method of claim 1, wherein populating includes receiving content from a user.

3. The method of claim 1, wherein the content includes any of a photograph, a graphical element, text, a theme, and background information.

4. The method of claim 1, wherein storing includes storing on a production server.

5. A method of ordering an authored product comprising:
receiving a request for an authored product type;
identifying product specification data associated with the authored product type;
presenting one or more options for authored products characterized by the product specification data;
receiving a request for one or more of the presented options; and
transmitting product order data associated with the request to a server.

6. The method of claim 5, wherein the product order data include the product specification data.

7. The method of claim 5, wherein the server is a production server.

8. A method of producing an authored product comprising:
receiving product order data associated with the authored product;
identifying print output data associated with the authored product;
generating one or more tables of contents, each table of contents defining one or more components of the authored product; and
printing the product components defined by the tables of contents.

9. The method of claim 8, further comprising identifying product specification data associated with the authored product.

10. The method of claim 8, wherein the print output data includes a PDF file.

11. The method of claim 8, wherein the print output data includes Extensible Markup Language information.

12. The method of claim 8, wherein the print output data includes a JPG file.

13. The method of claim 5, further comprising:
receiving product order data associated with the authored product;
identifying print output data associated with the authored product;
generating one or more tables of contents, each table of contents defining one or more components of the authored product; and
printing the product components defined by the tables of contents.

14. A computer readable storage medium, having embodied thereon a program, the program executable by a processor and operable to perform a method comprising a method according to any of claims 1, 5, or 8.

15. A computer readable storage medium, having embodied thereon a program, the program executable by a processor and operable to perform a method comprising:
receiving product order data associated with an authored product;
identifying print output data associated with the authored product;
generating one or more tables of contents, each table of contents defining one or more components of the authored product; and
storing the tables of contents.

16. The method of claim 15, further comprising printing any of the product components defined by the tables of contents.

17. A method of selecting pages to be printed from a PDF file including a plurality of book blocks, the method comprising:
creating a table of contents defining one or more selected book blocks, each selected book block corresponding to a book block that will be printed; and
appending the table of contents to the PDF file, such that the appended table of contents causes only the selected book blocks to be printed.

18. A method for producing a first product having a first height, width, and aspect ratio using print output data associated with a second product having a second height, width, and aspect ratio, the method comprising:
determining an average aspect ratio from the first and second aspect ratios;
calculating print output data for the first product, the calculated print output data being characterized by the average aspect ratio; and
resizing the calculated print output data such that the resized print output data meets or exceeds the height and width of the first product.
